(19) United States
(12) Patent Application Publication
(10) Pub. No.: US 2008/0053902 A1
(43) Pub. Date: Mar. 6, 2008

(54) Method for separation of substances using mesoporous or combined mesoporous/microporous materials

(76) Inventors: Johannes Koegler, Montclair, NJ (US); Zhiping Shan, The Woodlands, TX (US); Xingtao Gao, Edison, NJ (US); Philip Angevine, Woodbury, NJ (US); Jacobus Jansen, Delft (NL)

Correspondence Address: MCCARTER & ENGLISH LLP;CITYPLACE I, 185 ASYLUM STREET, HARTFORD, CT, 06103, US

(21) Appl. No.: 11/513,706

(22) Filed: Aug. 31, 2006

(51) Int. Cl. C02F 1/42

(52) U.S. Cl. 210/638; 210/649; 210/656; 210/650; 436/161; 436/86; 95/45; 95/90

(57) ABSTRACT

Methods are provided for separation of substances using non-crystalline, amorphous inorganic oxides having mesoporosity or combined meso- and microporosity. The amorphous inorganic oxide may have a separating agent, such as a chemical functional group, bonded or attached to the surfaces within the pores. The amorphous inorganic material is exposed to a fluid containing two or more materials to be separated. At least one material contained in the fluid is preferentially retained by the amorphous inorganic oxide either on the surface of the inorganic oxide within the pores or by interaction with a separating agent group attached to the pore surfaces.

The present invention is directed to methods for separation of substances using non-crystalline, amorphous inorganic oxides having mesoporosity or combined meso- and microporosity. The amorphous inorganic oxide may have a separating agent, such as a chemical functional group, bonded or attached to the surfaces within the pores. The amorphous inorganic material is exposed to a fluid containing two or more materials to be separated. At least one material contained in the fluid is preferentially retained by the amorphous inorganic oxide either on the surface of the inorganic oxide within the pores or by interaction with a separating agent group attached to the pore surfaces.

### BACKGROUND OF THE INVENTION

Porous inorganic solids have been used as catalysts and separation media for various industrial applications, such as hydrocarbon conversion. Due to the increased surface area provided by the pores, the porous materials used in these applications typically exhibit enhanced catalytic and sorptive activity. The porous inorganic solids used as catalysts and separation media are generally divided into three types: (1) crystalline materials, sometimes referred to as molecular sieves, (2) amorphous and paracrystalline materials, and (3) modified layered materials. Porous inorganic materials can be characterized as one of these three types by measuring properties such as surface area, pore size and variability of pore size, the presence or absence of X-ray diffraction patterns, and the appearance of the material when studied using transmission electron microscopy.

Crystalline materials used as catalysts or separation media include zeolites and related materials. Crystalline zeolites, such as aluminosilicates, possess well-arranged pore systems and display relatively uniform pore sizes for a particular type of zeolite material. These crystalline materials have a definite crystal structure as determined by X-ray diffraction. However, these materials typically possess either only micro- or only mesopores, and tend to have a narrow pore size distribution.

Amorphous and paracrystalline materials have also been used for many years in catalyst formulations. Amorphous materials, such as for example the amorphous silicas, generally exhibit no long range order, although they may exhibit order to some degree on a small scale. Because there is no long range order in these materials, the pore sizes tend to be distributed over a wider range than the crystalline materials. Amorphous materials usually have featureless X-ray diffraction patterns due to this lack of long range order.

Paracrystalline materials, such as for example the transitional aluminas, generally exhibit better defined X-ray diffraction patterns than the amorphous materials, usually consisting of a few broad peaks. These materials also have a relatively wide distribution of pore sizes.

Although there are some differences in the structure of amorphous and paracrystalline materials, neither type of material has long-range order controlling the pore size. As a result, variability of pore size in these materials can be high. The pore size in these materials falls within the range that is typically referred to by those skilled in the art as the “mesoporous range”, which is in the range of about 2 to 50 nm.

Layered materials typically have layers which are spaced apart with a swelling agent. Water-swellable materials include clays, in which layers of clay are spaced apart by water molecules. Other layered materials may be swellable with organic swelling agents such as amines and quaternary ammonium compounds. Examples of these types of materials include layered silicates, magadiite, kenyaite, trititanates and perovskites. After a layered material is swollen, the material may then be pillared by inserting a thermally stable substance between the layers. While pillared layered materials can be useful in some applications, they are a different class of materials from the amorphous inorganic mesoporous materials used in the methods described herein.

The variations in the microstructure of the crystalline and amorphous/paracrystalline materials can result in important differences in the ability of the materials to function as catalysts or sorptive materials. For example, surface area, pore size and variability in pore size are parameters that will affect the catalytic or sorptive capacity of a particular material. Total pore volume is a particularly important parameter in sorption-based separations, as it affects the frequency in which regeneration or cycling is required in the particular separation.

The porous materials described above can be particularly useful to effect separation of substances contained in a mixture. Separation of substances in a mixture can take place by, for example, filtration or chromatography techniques. The porous materials can be used themselves as a separation means, or they can be used as a support for a liquid or a chemical functional group that effects the desired separation.

Separation of substances contained in a mixture occurs by flowing the mixture past the material used to effect the separation. For example, in liquid-liquid chromatography, a liquid mobile phase containing the substances to be separated flows past a stationary liquid phase which may be affixed to a solid substrate by physisorption or chemisorption. Separation occurs as a result of the relative tendency of at least one substance contained in the liquid mobile phase to partition into the liquid stationary phase.

In other types of chromatography, an inert solid can function as a separating agent or as a support mechanism for a separating agent such as, for example, a reactive molecule or a functional chemical moiety. The reactive molecule or functional chemical moiety is typically attached to the surface of the solid support material, often by chemical bonds, and interacts with a particular substance in the mixture to affect separation.

There are numerous types of chromatography in which an inert solid may be used, including, for example, ion exchange, reverse phase, partition affinity, elution, column, adsorption, flat-bed, batch, thin-layer, paper, gel permeation and size-exclusion based chromatography.

Porous solids may also be used in other separation technologies. For example, membrane separations often employ solid porous materials which have been deposited or coated onto an inorganic substrate to produce a thin layer membrane for use in material separations. Similar techniques can be used for constructing filters used in filtration and clarification procedures.

Many of the amorphous, paracrystalline and crystalline zeolite materials described above have disadvantages when used in separations. For example, many of the crystalline materials have a relatively small and/or a uniform pore size, which can exclude certain molecules and reduce the surface area available for the separation. In addition, many of the materials do not readily accept attachment of a functional group to their pore walls, lack thermal stability or behave unpredictably in response to changes in pH.

Materials having both micro- and mesopores are advantageous for use in separating particular materials. These bimodal materials can have an increased pore volume and surface area as compared to other materials. Accordingly, amorphous inorganic oxide support materials have been developed having a pore structure wherein at least part of the pores are in the mesopore size range and part of the pores are in the micropore size range. Materials of this type, and methods for producing these materials, are described in U.S. Pat. No. 6,358,486, U.S. Pat. No. 6,762,143, and U.S. Pat. No. 6,814,950, the contents of each of which are herein incorporated in their entirety.

Prior materials used as support materials, such as those described in U.S. Pat. No. 5,378,400, are generally crystalline materials having a regular structure and relatively uniform pore size. These materials have the disadvantage of limited available surface area and are less efficient in performing separations of molecules of various sizes.

Among the objects of the present invention is to provide improved methods for separating substances using an amorphous inorganic material, including a bimodal material having both micro- and mesopores, which is thermally stable under a range of pH. Another object of the present invention is to provide improved methods for separating substances using an amorphous inorganic material, including a bimodal material having both micro- and mesopores, which has pore walls that will retain functional reactive chemical moieties for separating materials. Other objects and advantages will be apparent to those skilled in the art based upon the description of preferred embodiments set forth below.

### SUMMARY OF THE INVENTION

The present invention is directed to methods of separating substances contained in a mixture of at least two components in a flowable condition using an amorphous, non-crystalline inorganic material, such as for example a bimodal material having micro- and mesopores. The amorphous, non-crystalline inorganic material may be used in separations as produced, or a separating agent, such as a chemical functional group, may be attached or bonded to the surfaces of the material. The functional groups can be selected to have an affinity for one of the substances to be separated from the mixture.

The separation is performed by flowing the mixture containing the components to be separated past the amorphous material. In preferred embodiments, the mesoporous material is incorporated into a chromatographic system, or is incorporated into a membrane. The chromatographic systems may include flat-bed, batch or column chromatography systems. Membrane separation techniques include filtration, clarification, dialysis, reverse osmosis, and gas or liquid diffusions.

Among the advantages of the methods of the present invention are improved efficiency in separating the substances in the mixture due to the increased surface area in the amorphous, non-crystalline inorganic material.

### DESCRIPTION OF FIGURES

FIG. 1 is an XRD pattern of the inorganic amorphous non-crystalline mesoporous material of Example 1.

FIG. 2 is an XRD pattern of the inorganic non-crystalline mesoporous material of Example 4.

FIG. 3 is a BJH Desorption dV/d log D curve for the inorganic non-crystalline mesoporous material of Example 4.

### DESCRIPTION OF PREFERRED EMBODIMENTS

The present invention is directed to methods for separating substances contained in a flowable mixture containing at least two components. The separation is performed by flowing the mixture past an inorganic, mesoporous, amorphous, non-crystalline material. The material may have a separating agent, such as a functional group, attached or bonded to the pore surfaces of the material. The separating agent can be selected to have an affinity for one of the substances to be separated from the mixture.

Amorphous, non-crystalline mesoporous inorganic materials that may be used in the methods of the present invention are described in U.S. Pat. Nos. 6,358,486, 6,762,143 and 6,814,950, the contents of each of which are incorporated herein by reference. The amorphous material may have substantially all of the pores in the material in the mesoporous range, and preferably between about 2 and 25 nm in diameter. In a preferred embodiment, the amorphous material has a pore structure in which at least part of the pores are in the mesopore size range (between 2 and 25 nm) and at least a part of its pores are in the micropore size range (between 0.7 and 2 nm). The amorphous material having both mesopores and micropores is referred to herein as “bimodal”. In this embodiment, the bimodal amorphous material includes at least about 3 volume percent of micropores, and preferably at least about 5 volume percent, and has a maximum of not more than about 60 percent by volume of micropores, and preferably not more than about 50 percent by volume. The bimodal amorphous material may have any volume of micropores within these ranges as desired for the particular separation being performed. The volume percentage referred to is based on the combined volume of mesopores and micropores in the amorphous material.

The amorphous material may be comprised of one or more inorganic oxides such as silicon oxide or aluminum oxide, with or without additional metal oxides. The inorganic oxide is preferably a silicate. Part of the silicon may be replaced by another metal, preferably by adding a source of the metal during the preparation of the material. The material may optionally include metal ions of groups IVB-IIB and IIIA, such as aluminum, titanium, vanadium, gallium, iron or other metal ions, as part of the mesoporous structure. Depending upon the nature of the metal ions added to the mesoporous structure, the properties of the material may vary. For example, by incorporating aluminum in silicates, it is possible to give the material acidic properties, whereas some other metals may result in alkaline properties, thus making it useful as an oxidation catalyst.

In one embodiment, the material has a bimodal pore structure including interconnected mesopores, i.e. pores having a pore diameter between about 2 and 25 nm. The mesopores are interconnected, and are believed to be formed by cages having a kind of “sausage structure”, the pores having a somewhat spherical shape, generally with two or more connections to other pores at opposite ends thereof. The amorphous material also contains domains or phases of micropores, which are connected to mesopores. There is a distinct peak of micropores and a distinct peak of mesopores in a plot of the derivative of pore volume against pore size. In general, the width of the micropore peak at half-height is no greater than 2 angstroms and generally no greater than 1 angstrom.

The mesoporous and mesoporous-microporous material described above is a pseudo-crystalline material, meaning that no crystallinity is observed by presently available x-ray diffraction (XRD) techniques. In some embodiments, the materials may have one peak in the XRD diffraction pattern, where 2θ is between 0.5° and 2.5°. The presence of one peak means that the material has an extremely regular structure without being crystalline. The regular structure is determined by a distribution of wall thicknesses in combination with a narrow size distribution of the sizes of the mesopores. The wall-to-wall distance of the mesopores is between about 2 to 35 nm, and preferably between about 3 and 25 nm.

The material as formed generally has an average surface area as determined by BET (N₂) of between about −250 and 1200 m²/g, and preferably between about 450 and 1200 m²/g. The combined micro- and mesopore volume determined by nitrogen adsorption will generally be between about 0.3 and 2.5 m²/g, and preferably between about 0.7 and 2.5 ml/g.

As discussed above, micropores are defined as pores having a diameter of less than 2.0 nm, while mesopores are defined as pores having a diameter in the range of 2 to 50 nm. The pore size distribution of materials may be determined by nitrogen adsorption and desorption, and producing, from the acquired data, a plot of the derivative of pore volume as a function of pore diameter.

In one type of amorphous material used in the methods of the present invention, the pore size distribution in the mesopore range is such that a pore size distribution curve of the derivative of pore volume (dV) as a function of pore diameter results in a curve wherein at a point in the curve that is half the height thereof (one-half of the maximum pore volume), the ratio of the width of the curve (the difference between the maximum pore diameter and the minimum pore diameter at half height) to the pore diameter at the maximum height of the plot (as hereinabove described) is no greater than 0.75.

The amorphous material used in the methods of the present invention may be made in the manner described in U.S. Pat. No. 6,358,486, the contents of which are incorporated herein in their entirety. This material can be distinguished from other porous inorganic solids by various techniques known to those skilled in the art, such as transmission electron microscopy and electron diffraction.

The inorganic, noncrystalline, amorphous mesoporous material used in the methods of the present invention is characterized as having a pore size of about 20 Å (2 nm) or greater as measured by sorption measurements, hereinafter more particularly set forth. Pore size is considered a maximum perpendicular cross-section pore dimension of the material.

The mesoporous material used as a solid support in the methods described herein may be modified in various ways if desired for a particular use. For example, as described in U.S. Pat. Nos. 6,814,950 and 6,762,143, the contents of each of which are hereby incorporated in their entirety, the amorphous material may include in its structure a preformed, finely divided crystalline zeolite material. The crystalline zeolite material may aid in producing a microporous structure within the amorphous mesoporous material.

The mesoporous inorganic material for use in this invention should be dehydrated, at least partially. This can be done by heating the material to a temperature in the range of 200° C. to 595° C. in an atmosphere such as air, nitrogen, etc. and at atmospheric, subatmospheric or superatmospheric pressures for between 30 minutes and 48 hours. Dehydration can also be performed at room temperature merely by placing the composition in a vacuum, but a longer time is required to obtain a sufficient amount of dehydration.

When used as a sorbent or catalyst component, the amorphous, inorganic material should be subjected to treatment, such as calcination, to remove part or all of any organic constituent. The material, especially in its metal, hydrogen and ammonium forms, can be beneficially converted to another form by calcination. This thermal treatment is generally performed by heating the material at a temperature of at least 400° C. for at least 10 minutes and generally not longer than 36 hours, preferably from about 1 to about 10 hours. While subatmospheric pressure can be employed for the thermal treatment, atmospheric pressure is desired for reasons of convenience, such as in air, nitrogen, ammonia, etc. The thermal treatment can be performed at a temperature up to about 1000° C.

The amorphous material described above may be modified for use in the methods of the present invention by attaching a separating agent, such as a functional group, to the wall of the material. As used herein, “functional group” means a reactive group of a chemical compound that may be anchored to the wall of the amorphous material. “Functionalization” means the incorporation or bonding of a chemical compound including a functional group to the wall of the mesoporous material. The functional group may be attached or grafted to the wall of the material by any means known to those skilled in the art, such as, for example, by reaction of surface hydroxyl groups with the functional component in the gas or liquid phase.

The separating agent may be in solid, liquid or gas form, and it may be anchored to the pore wall by one or more chemical bonds or adsorbed to the pore wall. For example, in one embodiment, a liquid phase separating agent may be adsorbed onto the pore walls. Upon contact with a mobile phase carrying a solute having greater solubility in the liquid separating agent, the solute will migrate out of the mobile phase and partition into the liquid separating agent based upon its relative solubility between the two phases. This embodiment maybe used, for example, in liquid-liquid chromatography systems.

In another embodiment, the separating agent is a solid anchored to the pore walls. The solid is preferably a chemical compound having a functional group. The chemical compound may be anchored to the amorphous mesoporous material by contacting the amorphous material with a treatment composition including the chemical compound. The chemical compound may be anchored or coupled to the pore walls by at least one chemical bond between the pore wall and the separating agent. The chemical compound may be selected to include a desired functional group so as to impart a separation specificity to the material. The functional group is selected to impart a preselected set of sorptive characteristics to the functionalized amorphous material. The resulting functionalized amorphous material is capable of performing a specified separation based upon the selective sorption of particular components within a mixture.

The amorphous material may also be modified for use in the methods of the present invention by selecting a specialized moiety as a separating agent or by coupling a specialized moiety to the functional groups attached to the walls of the amorphous material. The specialized moiety may promote further specificity in separating a component from a mixture. For example, ion exchange moieties may be coupled to a functional group attached to the wall of the amorphous material. A component within a mixture may then be retained by an ion exchange mechanism. In another example, a peptide, peptide fragment, or peptide conjugate may be coupled with a functional group and retain a component having a particular binding affinity to the peptide. The invention is not limited in this regard, and any appropriate specialized moiety known to those skilled in the art may be selected to achieve a desired separation. As a result, the mesoporous material used in the methods of the present invention can be specifically modified for use in a wide range of biological and chemical separations. For example, antibodies that interact with particular blood factors or enzymes may be coupled to the mesoporous material for use in blood processing or separation of selective plasma fractions. Likewise, specific antigens may be coupled to the material to bind and retain a selected antibody.

Additionally, the amorphous, mesoporous material of the present invention may be used in size exclusion-type separations with or without a separating agent or other functional group attached to the pore walls. Since the material affords the artisan with an improved ability to control pore size and shape, the material may be modified to perform a size exclusion function in a variety of applications.

In a size exclusion-based separation, the pore size is tailored so as to exclude larger molecules and allow smaller molecules to enter and become retained therein. Further specificity may be added to the separating capabilities of the material if the pore walls receive a separating agent or other functional group which is capable of retaining specified components of a mixture within the pores of the material. In particular, such a separation involves both a size exclusion separation as well as a retentive association of the separating agent with at least one component in the mixture to be separated. Consequently, the resulting material functions to perform an improved separation based upon size exclusion principles in conjunction with a specified interaction between a preselected separating agent and at least one component of a mixture.

As previously described, the separating agent incorporated in the method of the present invention may be a substance, such as a liquid or gas, suitable for adsorption upon the pore wall. In a preferred embodiment, the separating agent will be a solid anchored to the pore walls. Typically, these solids are functional groups which are anchored or incorporated into the mesoporous material using a particular method set forth below which involves contacting the material with a treatment composition comprising M′X′Y′n. In this manner, functional groups may be incorporated into the mesoporous material to perform a separation or provide unique catalytic sites within the pores or, alternatively, to act as a pore size reducing agent so that the pore size may be tailored for the specific separation in which it is employed. Such functional groups may also serve to modify the performance (e.g. activity, selectivity, etc.) of catalytic sites already present in the mesoporous material.

The solid separating agents are preferably coupled to the pore walls by at least one chemical bond. The pore walls of the material may be functionalized so as to impart a separation specificity to the material or, additionally, to provide modification in pore size or shape. A variety of functional groups may be incorporated upon the pore walls, thereby providing a method of modifying the amorphous, mesoporous material so that it may be employed in a host of separation technologies. In particular, certain functional groups may be attached to the pore walls of the material to impart a preselected set of sorptive characteristics thereto. Consequently, the resulting modified material is capable of performing a specified separation based upon the selective sorption of particular components contained within a mixture.

Generally, most of the functional groups and specified moieties mentioned above are solids and are incorporated into the mesoporous material by way of a functionalization reaction. In a preferred embodiment, this reaction may be described according to the formula:

M—O—R′+M′X′Y′n→.MOM′Y′n+R′X′

wherein
M—O—R′ is a structural site in the mesoporous material.
M represents the mesoporous material, and is preferably an oxide of Si, Al, Si/Al, Ti, or Ti/Si.
R′=H+ or R4 N+ which is the organic cation specified in the synthesis methods described herein below.
M′=Elements of Groups IIA, IIIA, IVA, VA, VIA, VIIIA, IB, IIB, IIIB, IVB, VB, or VIB of the Periodic Table of the Elements, (Sargent-Welch Scientific Co. Cat. No. S-18806, 1979). Preferred elements for M′ are Groups IVA, VIA, VIIIA, IIIB and IVB, and most preferred elements for M′ are titanium, chromium, iron, cobalt, nickel, boron, aluminum and silicon.
X′ are halides, hydrides, alkoxides of 1-6 carbon atoms, alkyls of 1-18 carbon atoms, alkenyls of 1-18 carbon atoms, aryls of 1-18 carbon atoms, acetates, aryloxides of 1-18 carbon atoms, sulfonates and nitrates. Preferred substituents for X′ are halides, alkoxides of 1-6 carbon atoms and acetates.

Y′ can be selected from the substituents described for X′, or amines, phosphines, sulfides, carbonyls and cyanos. Preferred substituents for Y′ are those described for X′, amines and sulfides. Most preferred substituents for Y′ are those described for X′ and amines; and n=1-5.

Nonlimiting examples for M′X′Y′n include chromium acetate, chromium nitrate, tetraethylorthosilicate, tetramethylorthosilicate, titanium tetraethoxide, aluminum isopropoxide, aluminum tri-sec butoxide, hexamethyldisilazane, di-sec-butoxyaluminoxytriethoxysilane, diethylphosphatoethyltriethoxysilane, trimethylborate, chlorodimethylalkylsilane wherein alkyl has 1-18 carbon atoms, ammonia-borane, borane-tetrahydrofuran and dimethylsulfide-dibromoborane.

The ratio of treatment composition to treated composition of matter, duration of treatment and temperature are not critical and may vary within wide limits. The temperature may be, for example, from about −70° C. to about 250° C., with from about 25° C. to about 100° C. preferred; and the time may be from about 0.1 to about 100 hours, with from about 0.1 to about 30 hours preferred and from about 0.1 to about 24 hours most preferred.

The treated material can be used as is or may be further subjected to a thermal treatment or treatment with a reactive gas such as oxygen or carbon monoxide for activation. The treated material may be calcined in a reactive or inert gas such as NH₃, PH₃, air, O₂, N₂, Ar, SiH₄, H₂ or B₂H₆.

As discussed above, when used as a sorbent, the composition of the invention should be subjected to treatment, such as calcinations, to remove part or all of any organic constituent. The present composition can also be used as a catalyst component in intimate combination with a hydrogenating component such as tungsten, vanadium, molybdenum, rhenium, nickel, cobalt, chromium, manganese, or a noble metal such as platinum or palladium or mixtures thereof where a hydrogenation-dehydrogenation function is to be performed.

These components can be included in the composition by way of co-synthesis, exchanged into the composition to the extent a Group IIIB element, e.g. aluminum, is in the structure, impregnated therein or intimately physically and mixed therewith. For example, such components can be impregnated in or onto the composition by treating the silicate with a solution containing a metal-containing ion. Thus, suitable platinum compounds for this purpose include chloroplatinic acid, platinous chloride and various compounds containing the platinum amine complex.

The methods of the present invention are generally performed by fixing the amorphous mesoporous material, whether in as-synthesized or functionalized forms, in a stationary condition. The components to be separated are contained in a flowable mixture. The flowable mixture is brought into contact with the amorphous mesoporous material for a sufficient time and under suitable conditions for inducing retention of at least one component of the mixture within the pores of the amorphous material, thereby separating the component from other components within the mixture. The conditions required to achieve a desired separation can be readily determined by those skilled in the art based on the disclosures herein.

The flowable mixture may be in either liquid or gaseous form, or may be transported by way of a gaseous or liquid carrier medium. As described herein, the separating agent generally will be in solid or liquid form and anchored to the pore walls by physisorption or by at least one chemical bond. In particular, a liquid separating may be adsorbed upon the pore walls wherein the walls provide the requisite support.

In preferred embodiments of the methods of the present invention, the mesoporous material described above is used in a chromatographic system in which the mesoporous solid is used as a separating agent or as a support for the separating agent. The chromatographic system may be any type known to those skilled in the art for use in separating materials, including ion exchange, affinity, elution, column, adsorption, flat-bed, batch, thin layer and gel permeation chromatographic systems all incorporate solids in this fashion. Alternatively, paper chromatography utilizes paper as a support and some liquid solvent, typically water, as a stationary phase, thereby avoiding the need for any additional solid. Adapting the mesoporous solids for use in the various chromatographic methods set forth above are well-known to those skilled in the art and the appropriate modifications can be readily determined based upon the descriptions herein.

For example, if the mesoporous material is incorporated into a chromatographic system in order to perform a size exclusion-based separation, the material is usually disposed in a suitable column or, alternatively, in another format such as a gel matrix suitable for performing gel permeation chromatography. If the mesoporous material is instead used for ion exchange, affinity or some sorption-based chromatography, the material is usually incorporated into various chromatographic configurations, such as flat-bed, batch and column chromatography systems, depending upon the particular requirements of the separation to be performed. As will be recognized by those skilled in the art, various chromatography techniques may be combined in order to solve unique separation problems.

In addition to chromatographic techniques, the separation method of the present invention may be adapted for performing a separation in other technologies which require a solid as a means for separation or as a solid support for a separating agent. For example, the present methods include the use of the mesoporous material in membrane-based separation techniques including filtrations, clarifications, membrane reactions and other membrane-related separations, such as ultrafiltration, dialysis, electrodialysis, reverse osmosis, gas or liquid diffusions and facilitated transport mechanisms.

Preferably, the membrane-based separation methods set forth above are accomplished by incorporating the mesoporous material into a suitable membrane. The mesoporous material is incorporated into a suitable membrane either before or after any desired functionalization of the mesoporous material is performed to impart any additional separation selectivity to the material. In particular, the membranes utilized in these membrane-based separations can be constructed so as to incorporate any variation of the mesoporous material described above, provided that the set of separation conditions in which the membrane operates does not appreciably inhibit the efficiency of the separation.

After the mesoporous material has been treated to impart any desired functionalization, it can be formed into a thin cohesive, continuous, unsupported membrane under synthesis conditions familiar to those skilled in the art. Typically, synthesis of the material into a continuous layer is induced upon a non-porous forming surface and the material is subsequently removed in order to obtain a thin, non-composite membrane. Examples of procedures for fabricating non-composite membranes have been described in U.S. Pat. Nos. 3,392,103, 3,499,537, 3,628,669, 3,791,969, 3,413,219 and 4,238,590, all of which are incorporated herein by reference thereto.

Alternatively, the functionalized mesoporous material may be deposited onto a porous, inorganic substrate in order to form a thin layer composite membrane. Examples of procedures involving the formation of composite membranes or filters containing dispersed particles of mesoporous materials have been described in U.S. Pat. Nos. 3,266,973, 3,791,969, 4,012,206, 4,735,193 and 4,740,219, the disclosures of which are also incorporated herein by reference thereto.

The membrane can be produced, for example, by synthesis under hydrothermal conditions on a non-porous substrate forming surface, such as a polymer, a metal or glass. Suitable polymer surfaces are, for example, fluorocarbon polymers such as tetrafluoroethylene (TFE) and fluorinated ethylene-propylene polymers (FEP). Suitable metal surfaces are, for example, silver, nickel, aluminum and stainless steel. A thin layer of metal on glass or an organic polymer or other material may be used as the forming surface. A thin layer of a polymer film on glass or other material may also be used as the forming surface. The forming surface may have various configurations. For example, the surface may be flat, curved, a hollow cylinder or honeycomb-shaped.

Once a membrane containing the mesoporous material has been formed, it may be incorporated into any suitable membrane-based separation method, including those mentioned above. In particular, a feedstream mixture including at least a first component at a first concentration and a second component at a second concentration is contacted with the separation membrane comprising the mesoporous material. The contact should occur under separation conditions such that the microstructure of the material present in the membrane affords a greater permeability of the first component through the membrane than the second component. As a result, an effluent stream is produced wherein the concentration of the second component has been substantially reduced.

Generally, the feedstream mixture will contain the components in either a gaseous or liquid form so that they are readily flowable for contact with the membrane. Alternatively, the feedstream mixture may contain the components suspended in a liquid or gaseous carrier medium so that they are suspended for contact with the separation membrane.

Additionally, another separation technique contemplated by the method of the present invention involves utilizing the membrane as a membrane reactor. Typically, the membrane is rendered catalytically active by methods known to those skilled in the art and a feedstock is passed through the upstream face of the membrane under catalytic conditions. For cases where some or at least one of the reaction products have a higher permeability than the reactant(s), they will emerge from the downstream side of the membrane. In equilibrium limited reactions, this approach will lead to higher single-pass conversion of the reactant(s) than normally provided by thermodynamic equilibrium constraints. At least one or all of the reaction products are collected on the downstream side of the membrane.

Other applications of membranes incorporating the mesoporous material of the present invention as membrane reactors are well-known in the art and generally involve two unit operations, namely a separation and a chemical reaction. Generally, product separation translates into enhanced selectivity by depressing undesirable side reactions and/or increased conversation due to equilibrium shifting and/or the same conversion at a lower temperature. Examples of membrane reactors incorporating the unique material and methods of the present invention include enzymatic catalysis for various biological laboratory manipulations such as protein hydrolysis, cellulose saccharification and monoclonal antibody production.

The following examples of preferred embodiments of the methods of the present invention are provided for illustrative purposes only, and are not intended to limit in any way the full scope of the invention described and claimed herein. As will be recognized by those skilled in the art, numerous changes and modifications can be made to the methods described herein without departing from the scope of the invention as described herein or defined in the appended claims.

### EXAMPLE 1

An inorganic mesoporous material for use in the methods of the present invention was prepared according to the following example:

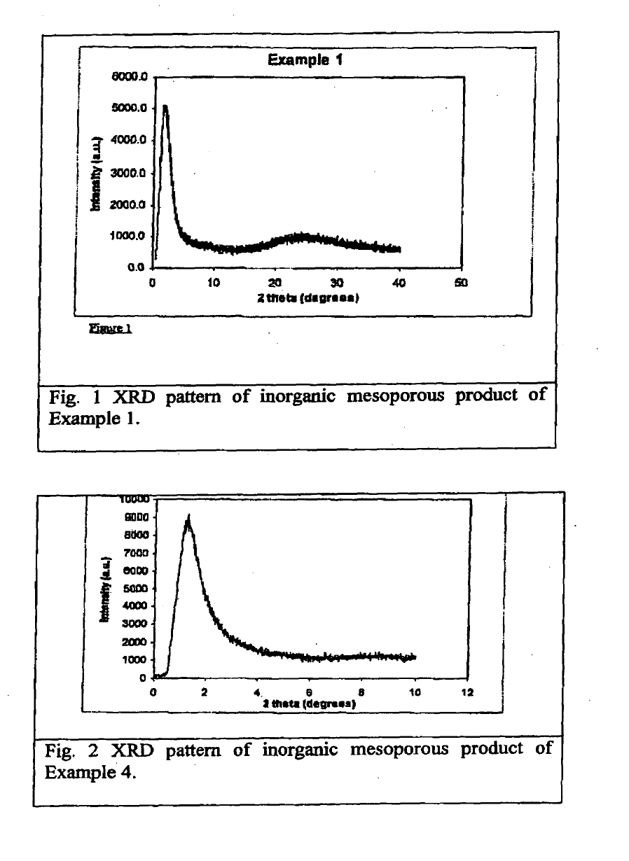

First, 1.3 parts of aluminum isopropoxide was dissolved in 39.1 parts of a TPAOH tetrapropylammonium hydroxide (40%) aqueous solution. Next, 47.88 parts of triethanolamine (97%, ACROS) and 14.0 parts of water were mixed. The triethanolamine mixture was added drop-wise (8-10 parts/min) to the aluminum containing mixture under stirring. Finally, 33.1 parts of tetraethyl orthosilicate (98%, ACROS) were added drop-wise (4-6 parts/min) to the resulting mixture while stirring. The final mixture was aged at room temperature for 48 hr, spread out to form a layer with a height of 1.0-1.2 cm, and dried at 100° C. for 18 hr in a static air furnace. The resulting material was calcined in air using the following procedure: with a heating rate of 1° C./min to 500° C., hold for 4 hours, with 1° C./min to 550° C., hold for 10 hr. The X-ray pattern of the resulting product is shown in FIG. 1. The N₂ porosimetry results are given in Table 1.

### EXAMPLE 2

A 0.50 parts portion of a calcined product prepared in Example 1 is added to a rapidly stirred solution of 10 parts chlorotrimethylsilane in 15 parts of hexamethyldisiloxane. The mixture is refluxed under N₂ overnight, cooled, the reagents removed on a rotary evaporator, the product washed with two 10 parts of acetone and air dried to yield 0.53 parts of product.

Solid state magic angle spinning NMR spectrum of this product can be obtained, and should show peaks at 15 and −108 ppm. The peak at 15 ppm has been assigned to trimethylsilyl groups (T. Yanagisawa, et al., Reactivity of Solids, vol. 5, p. 167 (1988)) and shows that the product has reacted. Integration of the two peaks should show that a considerable portion of the silicon atoms in the original product have been converted.

(A) Water sorption is measured before and after the chlorotrimethylsilane treatment. The calcined product of Example 1 should sorb more water than the treated material. The calcined product should sorb about 15.0 weight percent water at 30° C. and 12.5 torr while the treated material should sorb about 5.0 weight percent water. This will demonstrate that trichloromethylsilane treatment increases the hydrophobic character of the novel material.

(B) Sorption selectivity of a portion of the calcined product of Example 1 is demonstrated by contact with a water/hexane mixture (50/50, by volume) before and after the chlorotrimethylsilane treatment in (A) supra. The treated material should selectively adsorb hexane compared to water from this mixture.

(C) Sorption selectivity of a portion of the calcined product of Example 1 is demonstrated by contact with a water/hexadecane mixture (50/50, by volume) before and after the chlorotrimethylsilane treatment in (A) supra. The treated material should selectively sorb hexadecane compared to water from this mixture.

(D) Sorption selectivity of a portion of the calcined product of Example 1 is demonstrated by contact with an ethanol/benzene mixture (50/50, by volume) before and after the chlorotrimethylsilane treatment in (A) supra. The treated material should selectively sorb benzene compared to ethanol from this mixture.

(E) Sorption selectivity of a portion of the calcined product of Example 1 is demonstrated by contact with a water/p-xylene mixture (50/50, by volume) before and after the chlorotrimethylsilane treatment in (A) supra. The treated material should selectively sorb p-xylene compared to water from this mixture.

By functionalizing the material, the internal pore volume can be engineered to a desired size, thereby obtaining a predetermined set of sorptive characteristics, which may be advantageously used in the separation of a first component from a second component. By increasing the silicon content of the material as in (A), the hydrophobic character of the crystalline material should also increase. This property is useful in separating water from water/hydrocarbon mixtures.

### EXAMPLE 3

A portion of a product prepared in accordance with Example 2 is packed into a chromatographic column according to well-known procedures. A sample including adamantane, diamantane and triamantane at various flows is introduced at the head of the column and is allowed to pass through it. From the end of the column triamantane should emerge first followed by diamantane and adamantane.

This example illustrates a size exclusion separation. The ultra large pore material is modified by functionalizing its structure as in Example 2. Consequently, a sample having a pore size of about 20 Å is reduced to about 8 Å. The functionalized material should be effective in separating adamantane from a mixture containing its trimers and dimers. The critical molecular diameter of adamantane is 7 Å; diamantane is 7×11 Å; and triamantane is 11×12 Å. Because the pore size of the functionalized material is narrow, the separation of adamantane from its trimers and dimers is highly effective.

### EXAMPLE 4

An inorganic, mesoporous, silica-alumina material having uniform pores was prepared.

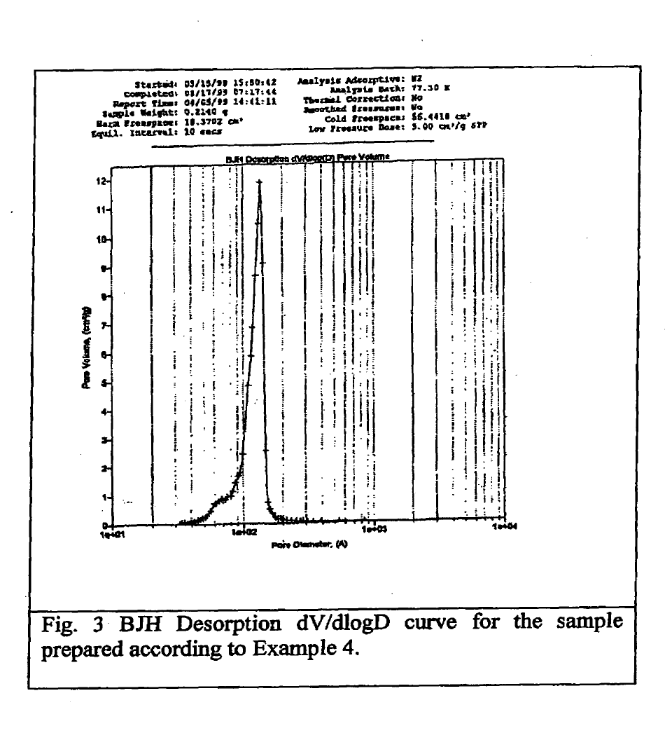

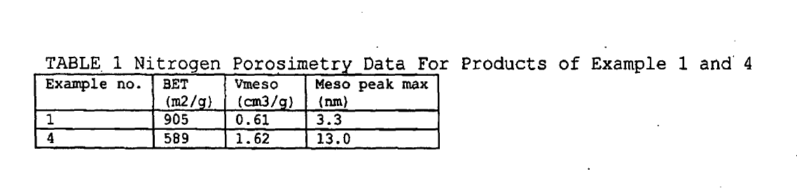

A mixture of 2.1 parts of aluminum isopropoxide and 60.6 parts isopropanol was made. To this mixture 53.06 parts tetraethyl orthosilicate (98%, ACROS) was added drop-wise (8-10 parts/min). Next, a mixture of 38.39 parts triethanolamine (97%, ACROS) and 114.37 parts water was added drop-wise (8-10 parts/min) to the mixture above. Finally, 31.5 parts tetraethyl ammonium hydroxide was added slowly (4-6 parts/min) while stirring. The final mixture was aged at room temperature for 24 hr. The mixture was allowed to form a layer with a height of 1.8-2.0 cm and dried in a static air furnace at 100° C. for 24 hr. The dried product was hydrothermally treated at 190° C. for 24 hr. Calcination took place in air at a heating rate of 1° C./min to 500° C., holding for 4 h. followed by heating at 1° C./min to 600° C. and holding for 10 hr. FIG. 2 shows the X-ray diffraction pattern of the product. The N₂ porosimetry results are given in FIG. 3 and Table 1.

### EXAMPLE 5

The product obtained in Example 4 is functionalized by treatment with titanium tetraethoxide. One part of the air-dried product of Example 4 is mixed with one part titanium tetraethoxide at room temperature for 16 hours. The mixture is then reacted with 5 parts of water for one hour. N₂ porosimetry should show a pore volume of about 1.5 cc/g.

### EXAMPLE 6

The product obtained in Example 4 is functionalized by treatment with aluminum tri-sec-butoxide. One part of the air dried product of Example 4 is mixed with one part aluminum tri-sec-butoxide at room temperature for 16 hours. The mixture is then reacted with 5 parts of water for one hour. N₂ porosimetry should show a pore volume of about 1.0 cc/g.

Example 4 describes a synthesis procedure for the mesoporous material. Examples 5 and 6 will demonstrate that functionalizing the material can be used to change its sorptive and consequently separation characteristics from about 1.5 cc/g in Example 5 to about 1.0 cc/g in Example 6.

### EXAMPLE 7

The product obtained in Example 4 is coated with a polyethylene glycol (PEG) such as Carbowax 20M by slow evaporation of a solution of the glycol in tetrahydrofuran in which the material is suspended. Vacuum rotary evaporation is a particularly convenient method of coating.

Loadings of from 0.1-5% PEG may be used in packed gas chromatography columns in a conventional manner. They are particularly advantageous for separations of trace quantities of alcohols and ethers, for example, ethanol or methyl t-butylether, in hydrocarbons, for example, gasoline.

At loadings of 20-100% PEG (100%=1 g polyethylene glycol/g mesoporous material) the capacity for polar materials, such as alcohols, amines, and ethers, should be so high that the modified materials may be used as concentrators. A stream containing <100 ppm of the polar compound(s) is passed at low temperature over the material until the effective concentration has been raised to a desired level (10-50 times for analytical purposes). The temperature of the material is then raised rapidly and the polar materials released either for analysis or collection.

### EXAMPLE 8

Preparation of dimethyloctylsilylated mesoporous material is performed by adding to 100 parts dimethylformamide first 25 parts chlorodimethyloctylsilane, followed by 4.0 parts of as-synthesized, dried mesoporous material. After mixing for 16 hr in a closed vessel at room temperature, the product is filtered, and the solid is washed with chloroform and dried. Elemental analysis and solid state NMR should indicate an organic loading of about 36% and a conversion of about 21% of the silicon atoms to derivatized silicons.

### EXAMPLE 9

The material of Example 8 is packed into a reverse phase HPLC (high performance/pressure liquid chromatography) column according to known procedures.

A sample containing benzene, anisole, phenol, and sodium benzenosulfonate is introduced into the column and allowed to pass through it using water as the eluting solvent. The solvent composition is gradually changed from water to methanol or from water to acetonitrile. The samples should emerge from the column in reverse order of their polarity, that is, sodium benzenesulfonate first, then phenol, then anisole, with benzene last.

### EXAMPLE 10

A mesoporous material is prepared according to Example 1. The material should have very high mechanical strength over extended periods of time and withstand elevated temperatures of up to about 700° C. This material is filled with homogeneous polymer gels. A monomer or a mixture of monomers to be polymerized is added in a concentration of 0.1-10 parts per part of porous material. Preferably the monomer volume is 5-100% by volume larger than the inside volume of the solid. The volatile solvent is removed in a vacuum of 0.1-300 mbars to the temperature of 0-100° C. In order to apply smaller quantities of the monomer, the monomer is additionally diluted with less volatile and inert solvents such as toluene or xylene. Suitable monomers are all those proper for radical polymerization such as olefins, styrene derivatives, acrylic derivatives, and methacrylate derivatives. A suitable initiator such as peroxides or azo compounds may also be added to the monomer mixture. Then the mixture is heated for 1-100 hours at 20-120° C. Other known methods may be employed to initiate the polymerization, such as anionic, cationic, or coordinate polymerizations.

After polymerization, the chemically non-bound polymer is exhaustively rinsed with a suitable solvent and thereupon the mesoporous material filled with the polymer is dried. In this way, a highly advantageous, hard material of smaller uniform pore size having high mechanical strength may be provided. The foregoing material is packed into a gel chromatography column according to known procedures.

A sample containing polystyrene 111000, polystyrene 5000, tristearin, triacontane, eicosane, tetradecane, and octane at various flowrates is introduced at the head of the column and allowed to pass through it. As the molecules progress through the column of the invention, the small molecules of tristearin to octane should enter the pores of the mesoporous material, while the large molecules of polystyrene 111,000 and 5,000 continue to flow down the column. The samples should emerge from the end of the column in reverse of molecular size, with the larger molecules eluting first. In this case the separation is as follows: polystyrene 111,000, polystyrene 5,000 followed by the remaining components tristearin, triacontane, eicosane, tetradecane, and octane.

### EXAMPLE 11

A portion of five parts of mesoporous material is prepared as described in example 1. The portion is dried overnight at 200° C. and then refluxed with 50 parts toluene, 5 parts gamma-glycidoxypropyltrimethoxysilane and 0.5 parts water. This material is dried at 70° C. in vacuum and then treated with 50 parts of a 10% solution of polyethyleneamine (MW=600) for 24 hours at room temperature. This material is dried under vacuum to make a polyamine-functionalized mesoporous material, which is further refluxed with 5 parts of propanesultone and 10 parts acetonitrile to make a propane-sulfonated material. This material is packed into a chromatography column according to well-known methods. A mixture of uracil, adenosine, and bovine insulin is injected in the column. The elutant is a dilute solution of ammonium phosphate buffer. The insulin will elute first because of size exclusion, followed by the uracil and then the adenosine. The latter two are separated on the basis of their polarity. This example illustrates the use of the functionalized mesoporous material for chromatographic separation where the separation is achieved by size exclusion. In addition, some of the other components are also separated due to different polarity of the components. It has been found that if an amorphous silica gel column (such as Fisher S-679) is prepared as above, the insulin does not elute at all because no size exclusion separation takes place and the insulin binds strongly to the polar surfaces of the silica gel.

### EXAMPLE 12

The pore walls of the mesoporous material are functionalized for protein attachment by coupling through two oxygen atoms, one oxygen coupled to the pore walls and one oxygen coupled to the protein.

500 parts of mesoporous material is suspended in a solution of 2 parts NaBH4 in 1000 parts of 1 M NaOH. This suspension is incubated with 1-5 volumes of bis-epoxide (bis-oxiran, oxiran, butandiodiglycidyl ether) under vigorous shaking at 25° C. for about five hours. The bisepoxide phase disappears. The resulting oxiran activated mesoporous material is removed from suspension by centrifugation, washed thoroughly with water and again centrifuged.

The oxiran-activated mesoporous material is resuspended in a solution of 2 parts NaBH4 in 1000 parts 1 M NaOH and incubated with ovalbumin protein overnight. Excess oxiran groups in the suspension are then inactivated with an excess of ethylamine, and the suspension is subjected to successive washes as follows:

1. neutral wash—H2O
2. high pH wash—0.1M potassium borate, pH 8.0
3. high salt—0.5M NaCl
4. low pH wash—0.1M potassium acetate, pH 4.0
5. high salt—0.5M NaCl
6. neutral wash—H2 O, pH 7.0

After the ovalbumin protein is coupled to the surface, it can be used for direct coupling to antibodies through the NH2 groups present on the antibody.

Antibodies can also be coupled to the surface through the following groups: carbonyldiimidazole, cyanogen bromide, glutaraldehyde, hydroxysuccinimide and tosyl chloride which are first fastened to the pores walls by appropriate functionalization chemistry known in the art.

After the antibody is coupled to the surface of the protein bearing mesoporous material, it can be used for coupling with its corresponding antigen.

### EXAMPLE 13

Finely divided material obtained in accordance with any one of the methods described in U.S. Pat. No. U.S. Pat. Nos. 6,358,486 and 6,762,143 is added dry or as a concentrated slurry to a solution or slurry of fibrous materials, for example, containing from 1-6 wt % of paper pulp. The mesoporous material is intimately dispersed before a fibrous stock is formed, molded, sheeted, extruded, calendered, or cast in final form. For example, the mesoporous material can be added to the aqueous paper making pulp slurry at the wet end of the machine known as “beater addition.” Addition of the material can be made to beaters, hydropulpers, jordans, fiberizing mills, as well as to a stuff box, head box, etc. or other pulp refining and preparation devices. The mesoporous particles should be thoroughly distributed throughout the pulp while the latter is suspended in an aqueous medium. If the particles are mixed with the pulp or paper making stock in a beater, then beating of the pulp must be continued while the particles are intimately distributed. On the other hand, if the particles are added as a slurry in water, the particles should be distributed as uniformly as possible throughout the pulp by using commercial methods of stirring, mixing, and beating or dispersing.

After the particles are dispersed or distributed substantially uniform throughout the pulp or paper-making stock, the mass-containing particles of mesoporous material are laid down, molded or shaped by conventional means.

The quantity of particles incorporated in paper products can be varied widely depending on the size of the particles, the basis weight of the paper, the degree of the refinement of pulp, and the ultimate use of the product. Amounts of 1-200% by weight of mesoporous material particles may be employed, with a preferred range from 10-150% so that the absorbing capacity of the paper is as high as possible. High weight ratios of mesoporous material particles to dry pulp result in higher absorbing capacity albeit weaker paper products.

Other modifying materials, commonly in amounts from 0.1-10 wt % may be added, such as conventional sizing agents, alum, natural or synthetic bonding agents and adhesives, loaders or fillers like carbonate, oxides, clays, dispersible carbon black, or dyes and pigments.

### EXAMPLE 14

A non-composite membrane is prepared by following the procedure outlined in U.S. Pat. Nos. 5,019,263, 5,069,794 and 5,100,596. Accordingly, a non-porous surface is contacted with a chemical mixture capable of forming the desired mesoporous material under synthesis conditions as described in U.S. Pat. Nos. 6,358,486 and 6,762,143. After a period of time under suitable conditions, a cohesive membrane of material forms on the non-porous substrate surface. The dimension of the membrane thickness may vary from about 0.02 microns to about 1000 microns depending upon the length of time the surface is contacted with the chemical mixture and the amount of mixture provided. Other means such as varying the temperature or the ratio of synthesis mixture to forming surface area are also effective in adjusting the membrane thickness to a desired dimension.

The surface contacting time with the reaction mixture may be from about 0.5 hr. to about 72 hr., preferably from about 1 hr. to about 10 hr. and at a temperature ranging from about 25° C. to about 175° C., preferably from about 50° C. to about 150° C.

After the desired period of time, the substrate, now coated with mesoporous material, is removed from contact with the chemical mixture, washed with distilled water and allowed to dry. The layer of mesoporous material may be removed from the non-porous surface by various means, depending upon the material chosen for the forming surface. The layer may be separated from polymeric or metal surfaces, by mechanical means such as careful peeling, or with the use of solvents such as acetone, or by dissolving the surface with suitable solvents. With a support consisting of metal or metallized material such as aluminum or glass or teflon, treatment with an aqueous mineral acid can be employed.

The membrane material may also be calcined before or after removal from the substrate, for example, in an inert atmosphere or in air at a temperature ranging from about 150° C. to about 700° C. for about 0.5 hr. to about 15 hr.

### EXAMPLE 15

A separation non-composite membrane is prepared in accordance with the procedure of Example 14. The non-composite membrane is geometrically arranged in any type of configuration which effects dialysis. A feedstream including plasma protein such as albumin and urea, uric acid and creatinine is fed through the non-composite membrane. A pressure differential is maintained across the membrane. The low molecular weight components, namely, urea, uric acid and creatinine diffuse easily through the membrane and exit as the permeate. The large protein molecules of albumin are collected as the retentate. This example illustrates the use of a non-composite membrane including the mesoporous material in a dialysis separation process.

### EXAMPLE 16

A porous inorganic substrate, which may itself be a membrane, is contacted with a synthesis mixture capable of forming the mesoporous material, as described in U.S. Pat. Nos. 6,358,486 and 6,762,143 after a period of time under suitable synthesis conditions, a thin mesoporous membrane is formed.

As a result, the pore openings of at least one side of the starting substrate are reduced in size by the mesoporous material. Thus, the resulting composite membrane has uniform pores of, for example, 20 Å, 40 Å, 60 Å, 80 Å, 100 Å, etc. The size of the pores of the mesoporous material and the thickness of the membrane are controlled by synthesis conditions and the nature of the starting materials or precursors.

Substrates contemplated to be used include, as non-limiting examples, glass, mullite, zirconia, silica, alumina, spinels, carbides (such as those of silicon, boron, zirconium, hafnium, tantalum, vanadium, molybdenum, tungsten and niobium), membranes made from these materials, metallic membranes made of stainless steel, nickel, silver, gold, platinum or commercially available porous inorganic membranes sold under the trade names: HYTREX®, UCARSEP®, CARBOSEP®, DYNACERAM®, MEMBRALOX®, CERAFLO®and ANOPORE®The substrates have various configurations such as tube, disk, or monoliths of various shapes. Asymmetric composite membranes of up to four layers are not uncommon consisting of a thin membrane film with 20-100 Å pore diameter openings and, for example, three layers of support having monotonically increasing nominal pore diameters of, for example, 0.05, 0.5 and 5 microns.

A composite membrane so formed is used to separate plasma protein from urea, uric acid and creatinine. Alternatively, a composite membrane so formed is used to separate pyrogens or endotoxins from a pyrogen-containing liquid by way of ultrafiltration in a manner analogous to that of U.S. Pat. No. 5,104,546 which is incorporated herein by reference. Endotoxins are fever inducing substances which derive from gram negative bacteria and which have high molecular weights of about 10,000 up to 100,000 to 200,000 and even as high as one million. Although endotoxins can be removed by other separation methods, such as distillation or reverse osmosis, ultrafiltration is preferred because it is less expensive and more efficient. A mixture containing plasma protein, urea, uric acid and creatinine is passed through a membrane coated composite. A pressure differential is maintained across said membrane. A permeate solution consisting of urea, uric acid and creatinine exits the mesoporous material containing membrane and leaves behind a retentate solution rich in plasma. Alternatively, a feedstream containing pyrogens and water is passed through a membrane coated composite. A pressure differential is maintained across said composite membrane. A permeate solution consisting of pyrogen-free water exits the membrane and leaves behind a retentate stream which is highly concentrated in pyrogens. This example illustrates the use of a composite membrane including mesoporous material for ultrafiltration where separation is based on size exclusion.

### EXAMPLE 17

A non-composite or composite mesoporous membrane of the types mentioned in Examples 14 or 16 above is loaded with palladium or silver by currently available methods to yield a dense membrane. A palladium-loaded membrane is permeable to hydrogen gas. A silver-loaded membrane is permeable to oxygen gas. Consequently, a palladium-loaded membrane may be used to separate hydrogen from, for example, alkanes, alkenes, naphthenes and aromatics or mixtures thereof or to remove trace quantities of hydrogen from a gas stream. This provides a highly cost-effective method of separating hydrogen from higher molecular weight hydrocarbons present in, for example, refinery exhaust streams. A silver-loaded membrane may be used to separate oxygen from air or to remove trace quantities of oxygen from a gas stream. Membranes produced in this fashion would be mechanically stronger than ultra or very thin films of metallic palladium or silver supported on grids whose maximum opening is greater than 100 Å and hence would be able to support very high pressure drops across them.

We claim:

1. A method for separating substances contained in a mixture comprising:
a. providing an inorganic, amorphous, noncrystalline mesoporous material having an X-ray diffraction pattern with one peak at a d-spacing greater than 25 angstroms and where 20 is between 0.5° and 2.5°; and
b. contacting the mesoporous material with a flowable mixture comprising at least a first component and a second component having different sorption characteristics, wherein the contact is maintained for a sufficient time under conditions for inducing retention of the first component in the mixture on the mesoporous material, whereby the first component is separated from the second component.

2. The method according to claim 1, wherein the mesoporous material has been treated to attach a separating agent to the surfaces of the mesoporous material.

3. The method according to claim 1, wherein the flowable mixture is in a gaseous form or in a gaseous carrier.

4. The method of claim 1, wherein the flowable mixture is in a liquid form or in a liquid carrier.

5. The method according to claim 1, wherein the mesoporous material contains micropores comprising between about 3 percent by volume and about 60 percent by volume of the total volume of mesopores and micropores in the material.

6. The method according to claim 2, wherein the mesoporous material is provided within a chromatography system selected from the group consisting of flat-bed, batch and column chromatography systems.

7. The method according to claim 1, wherein the mesoporous material is provided in the form of a separation membrane.

8. The method according to claim 7, wherein the mesoporous material is provided in a thin, cohesive continuous unsupported membrane by inducing formation of the mesoporous material in a continuous layer upon a non-porous forming surface and removing the resulting formed layer in order to obtain a thin, non-composite membrane prior to contact with said feedstream mixture.

9. The method according to claim 7, wherein the mesoporous material is provided by depositing the mesoporous material onto a porous, inorganic substrate in order to form a thin-layer composite membrane.

10. The method according to claim 7, wherein the membrane is loaded with a gas-permeable metal.

11. A method for chromatographic separation comprising contacting a stationary phase with a fluid mobile phase having a mixture of at least a first component and a second component having different partition or retention characteristics with respect to the stationary phase, the stationary phase comprising an inorganic, amorphous, noncrystalline mesoporous material having an X-ray diffraction pattern with one peak at a d-spacing greater than about 25 Å and where 2θ is between 0.5° and 2.5°, the contacting occurring for a sufficient time and under conditions suitable for inducing retention of the first component within the stationary phase, whereby the first component is separated from the second component by differences in physical characteristics selected from the group consisting of molecular weight, molecular size, solubility, ion exchange and binding affinity.

12. The method for chromatographic separation according to claim 11, wherein the mesoporous material includes a separating agent supported upon its pore walls, the separating agent being capable of a retentive association with at least one of the components present within the sample mixture to be separated.

13. The method for chromatographic separation according to claim 12, wherein the separating agent is disposed upon the pore walls of the mesoporous material by way of absorption.

14. The method for chromatographic separation according to claim 11, wherein the mesoporous material includes functional groups attached to the pore walls by way of a treatment comprising:
contacting the mesoporous material with a treatment composition comprising M′X′Y′.sub.n wherein,
M′ is selected from the group consisting of Periodic Table Groups IIA, IIIA, IVA, VA, VIA, VIIIA, IB, IIB, IIIB, IVB, VB and VIB;
X′ is selected from the group consisting of halides, hydrides, alkoxides of C.sub.1-6, alkyls of C.sub.1-18, alkenyls of C.sub.1-18, aryls of C.sub.1-18, aryloxides of C.sub.1-18, sulfonates, nitrates, and acetates;
Y′ is selected from the group consisting of X′, amines, phosphines, sulfides, carbonyls and cyanos; and
n=1-5; the contacting of the mesoporous material with the treatment composition occurring under conditions such that the pore walls of the mesoporous material becomes functionalized.

15. The method for chromatographic separation according to claim 14, wherein a specialized ion-exchanging moiety selected from the group consisting of peptides, peptide fragments and peptide conjugates is coupled to the functionalized pore walls to serve as the separating agent.

16. A method for membrane separation comprising contacting a separation membrane including an inorganic, amorphous, noncrystalline mesoporous material having an X-ray diffraction pattern with one peak at a d-spacing greater than about 25 Å and where 2θ is between 0.5° and 2.5°, with a feedstream mixture of components having different permeability characteristics including at least a first component at a first concentration and a second component at a second concentration, the contacting occurring under separation conditions such that the separation membrane affords greater permeability to the first component through the membrane than the second component, thereby producing an effluent stream wherein the concentration of the second component has been substantially reduced.

17. The method according to claim 16, further comprising providing the pores of said material with a specified pore size and shape so as to allow the first component to enter the pores and permeate while restricting the passage of the second component.

18. The method according to claim 16, wherein the mesoporous material is present in a thin, cohesive, continuous, unsupported noncomposite membrane.

19. The method according to claim 16, wherein the mesoporous material is deposited onto a porous, inorganic substrate to form a thin-layer composite membrane.

20. The method according to claim 16, wherein the mesoporous material further comprises a separating agent disposed upon the pore walls of the mesoporous material, the separating agent capable of a retentive association with at least one of the components present within a sample mixture to be separated.

21. The method according to claim 16, wherein the mesoporous material includes functional groups attached to the pore walls by way of a treatment comprising:
contacting the mesoporous material with a treatment composition comprising M′X′Y′.sub.n wherein,
M′ is selected from the group consisting of Periodic Table Groups IIA, IIIA, IVA, VA, VIA, VIIIA, IB, IIB, IIIB, IVB, VB and VIB;
X′ is selected from the group consisting of halides, hydrides, alkoxides of C.sub.1-6, alkyls of C.sub.1-18, alkenyls of C.sub.1-18, aryls of C.sub.1-18, aryloxides of C.sub.1-18, sulfonates, nitrates and acetates;
Y′ is s elected from the group consisting of X′, amines, phosphines, sulfides, carbonyls and cyanos; and
n=1-5; the contacting of the mesoporous material with the treatment composition occurring under conditions such that the pore walls of the mesoporous material become functionalized.

22. The method according to claim 21, wherein a specialized ion-exchanging moiety selected from the group consisting of peptide fragments and peptide conjugates is coupled to the functional groups attached to the pore walls to serve as the separating agent.

23. The method according to claim 16, wherein said membrane is loaded with a gas permeable metal.

24. A method for separating substances comprising contacting a mixture of components having different sorption characteristics including at least a first and a second component in a flowable condition with an inorganic, amorphous, noncrystalline, mesoporous material having a specialized moiety coupled to functionalized pore walls of said material, wherein prior to contact with the mixture the mesoporous material has been treated by contacting the mesoporous material with a treatment composition comprising M′X′Y′, wherein,
M′ is selected from the group consisting of Period Table Groups IIA, IIIA, IVA, VA, VIA, VIIIA, IB, IIB, IIIB, IVB, VB, and VIB;
X′ is selected from the group consisting of halides, hydrides, alkoxides of C₁₋₆, alkyls of C₁₋₁₈, alkenyls of C₁₋₁₈, aryls of C₁₋₁₈, aryloxides of C₁₋₁₈, sulfonates, nitrates, and acetates;
Y′ is selected from the group consisting of X′, amines, phosphines, sulfides, carbonyls and cyanos; and
n=1-5; the contacting of the mesoporous material with the treatment composition occurring under conditions such that the pore walls of the mesoporous material become functionalized.

25. The method according to claim 24, wherein an ion-exchanging moiety is coupled to the functional groups attached to the pore walls, whereby the first component is retained within the mesoporous material via an ion exchange mechanism.

26. The method according to claim 25, wherein the ion-exchanging moiety is selected from the group consisting of peptide fragments and peptide conjugates, whereby the first component is retained within the mesoporous material via a binding affinity for the ion-exchanging moiety.

27. The method according to claim 25, wherein the mesoporous material having a specialized moiety coupled to functionalized pore walls of the material is in the form of a separation membrane.
